(19) United States
(12) Patent Application Publication
(10) Pub. No.: US 2009/0068417 A1
(43) Pub. Date: Mar. 12, 2009

(54) Ink composition, inkjet recording method and recorded article

(75) Inventors: Chie Saito, Matsumoto-shi (JP); Miharu Kanaya, Azumino-shi (JP); Teruaki Kaieda, Matsumoto-shi (JP); Nagatoshi Kasahara, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/075,828

(22) Filed: Mar. 14, 2008

(30) Foreign Application Priority Data
Mar. 15, 2007 (JP) 2007-066150
Mar. 29, 2007 (JP) 2007-088954
Mar. 29, 2007 (JP) 2007-089653
Mar. 13, 2008 (JP) 2008-063983

(51) Int. Cl. C09D 11/10; C09D 11/02; B05D 5/00; B32B 3/10

(52) U.S. Cl. 428/195.1; 106/31.13; 427/256; 524/376

(57) ABSTRACT

An ink composition at least including: a pigment; a water-soluble organic solvent; a surfactant; and 60 to 10% by weight of water.

### CROSS-REFERENCES TO RELATED APPLICATIONS

The entire disclosure of Japanese Patent Applications No. 2007-066150, filed on Mar. 15, 2007, No. 2007-088954, filed on Mar. 29, 2007, No. 2007-089653, filed on Mar. 29, 2007, and No. 2008-063983, filed on Mar. 13, 2008, is expressly incorporated by reference herein.

### FIELD OF THE INVENTION

The present invention relates to an ink composition, an inkjet recording method, and a recorded article. More particularly, the present invention relates to an ink composition having superior cockling or curling characteristics, an inkjet recording method and a recorded article.

### DESCRIPTION OF THE RELATED ART

Inkjet recording is printing method for carrying out printing by spraying ink droplets from a printer head and causing the ink droplets to strike a recording medium such as paper. Since the ink used in this inkjet recording method is sprayed from a printer head, it is required to have low viscosity, and inks having a high water content are used. Thus, highly absorbent, special-purpose paper is used for the recording medium.

High-quality images can be realized through the use of highly absorbent, dedicated inkjet paper. However, unless a thick absorption layer is provided to absorb ink, the amount of absorbed ink is low, thereby resulting in an increase in the amount of ink applied. Moreover, costs have increased since fine silica powder or alumina and the like is used as a raw material to make the absorption layer transparent. These increased costs have become an obstacle that has narrowed the range of user applications.

Although copy paper and other ordinary paper is inexpensive, water absorbency is low as compared with dedicated inkjet paper. Consequently, ordinary paper is inherently unsuitable for use as recording media of inkjet recording methods. Although various inkjet recording inks have been developed in recent years that guarantee high-quality images even for inexpensive ordinary paper, it is inherently extremely difficult to attain the level of image quality of dedicated inkjet paper.

Printing coated paper (also referred to as coated paper or printing paper) is even more inexpensive than copy paper and other types of ordinary paper. Coated paper consists of a composite sheet in which a type of coating in the form of a coating color is coated onto both sides or one side of a base paper for the purpose of improving printability, and is exclusively provided for use in applications as printing paper. Coated paper is used in recording methods using highly viscous printing ink, and is not required to have water absorbency. Consequently, it does not require a thick absorption layer or highly transparent, expensive fine particles in the manner of dedicated inkjet paper. Moreover, as a result of being supported by a huge demand on the order of several million tons annually, production equipment is already in place and high-quality coated paper is available in an extremely stable supply.

Since the water absorbency of coated paper is even lower than that of ordinary paper as described above, it has been considered to be even more unsuitable than ordinary paper as a recording medium for inkjet recording methods. However, since the image quality of coated paper is of an extremely high level, technologies have been proposed for using this coated paper as a recording medium for inkjet recording methods.

For example, an inkjet recording method has been proposed that allows the obtaining of high-quality images without providing additional equipment for conventional systems, and using printing coated paper having low water absorbency and superior printability, by printing printed regions P1 and P2, capable of being printed with a single pass, by dividing into a plurality of passes, and not feeding paper during the time printing of the printed regions is completed with the plurality of passes (JP-A-2006-272732).

As has been described above, although combining the advantages of inkjet recording systems in terms of being simple and compact with printing coated paper having superior printability has been examined from the viewpoint of inkjet recording methods, studies have yet to be conducted from the viewpoint of the ink composition, and as such, room for improvement remains.

In addition, since coated paper lacks water absorbency as previously described, when printing was carried out on coated paper using a conventional ink composition, there have been problems in terms of phenomena such as so-called “cockling”, in which wrinkles form in the manner of waves formed in the coated paper after the ink has been discharged, or so-called “curling”, in which the coated paper itself rolls back.

Furthermore, although an aqueous ink containing pigment as colorant has recently been proposed comprising 5 to 15% by weight of a polyvalent alcohol monoether, having a water vapor pressure at 20° C. of 0.1 mmHg or less, and 5 to 50% by weight of a polyvalent alcohol, for the purpose of providing an ink and the like that simultaneously satisfies requirements relating to liquid stability, rapid drying, printing quality characteristics and low odor (Japanese Patent No. 3,102,304), there is no disclosure in this document indicating that the above-mentioned problems are solved.

### BRIEF SUMMARY OF THE INVENTION

Thus, an object of the present invention is to provide a technology for enabling printing coated paper having low water absorbency to be used directly as a recording medium without providing additional equipment for inkjet recording systems used in the prior art.

The present invention achieves the object described above by providing the invention of (1) below.

(1) An ink composition at least including: a pigment; a water-soluble organic solvent; a surfactant; and 60 to 10% by weight of water.

Preferable aspects of the above-mentioned invention are as indicated below:

(2) the ink composition described in (1) above, wherein the water-soluble organic solvent at least comprises 15% by weight or more of a polyvalent alcohol monoalkyl ether, having a water vapor pressure at 20° C. of 0.1 mmHg or less, and/or a nitrogen-containing cyclic compound, and a polyvalent alcohol;

(3) the ink composition described in (2) above, wherein the weight ratio (a):(b):(c) of the contents of the water (a), the polyvalent alcohol monoalkyl ether, having a water vapor pressure at 20° C. of 0.1 mmHg or less, and/or nitrogen-containing cyclic compound (b), and the polyvalent alcohol (c) is 1:0.25 to 8:0.1 to 7;

(4) the ink composition described in (2) or (3) above, wherein the polyvalent alcohol is a 1,2-alkanediol;

(5) the ink composition described in any of (1) to (4) above, wherein the pigment is contained at 6% by weight or more;

(6) the ink composition described in any of (1) to (5) above, wherein the pigment is a pigment coated with a water-insoluble polymer;

(7) the ink composition described in any of (1) to (5) above, wherein the pigment is a self-dispersing pigment;

(8) the ink composition described in any of (1) to (7) above, wherein the surfactant is an acetylene glycol-based surfactant and/or poly-modified siloxane-based surfactant;

(9) the ink composition described in any of (1) to (8) above, further comprising a resin emulsion;

(10) the ink composition described in (9) above, wherein the resin emulsion is a mixture of resin fine particles having a minimum film-forming temperature of 20° C. and above and resin fine particles having a minimum film-forming temperature of below 20° C.;

(11) an inkjet recording method for carrying out printing by discharging liquid droplets of an ink composition and adhering the droplets to a recording medium, wherein the ink composition described in any of (1) to (10) above is used; and

(12) a recorded article obtained by carrying out recording using the inkjet recording method described in (11) above.

### DETAILED DESCRIPTION OF THE INVENTION

### Ink Composition

The ink composition of the present invention is at least comprised of a pigment, a water-soluble organic solvent, a surfactant and 60 to 10% by weight of water as previously described.

The following provides an explanation of the ink composition of the present invention based on preferred embodiments thereof. Furthermore, an explanation of the present invention is provided for each embodiment of the ink composition.

### Embodiment A

As previously described, the ink composition of Embodiment A is at least comprised of a pigment, a resin emulsion, a water-soluble organic solvent, a surfactant and 50 to 10% by weight of water.

As a result of making the content of water contained in the ink composition within the above range, the amount of water absorbed by cellulose in coated paper is less than that of an ink composition of the prior art, and as a result thereof, swelling of the cellulose, which is thought to be a cause of cockling or curling can be inhibited. Thus, the ink composition of the present embodiment is also useful for a recording medium such as ordinary paper or printing coated paper (printing paper) having an absorption layer on a paper support lacking ink absorbency.

In the case the water content is less than 10% by weight, fixability to the recording medium may decrease. On the other hand, in the case the water content exceeds 50% by weight, cockling or curling occur easily when printing onto a recording medium having an absorption layer on a paper support lacking ink absorbency in the same manner as conventional aqueous ink compositions.

Pure water or ultrapure water, such as ion exchange water, ultrafiltered water, reverse osmosed water or distilled water, is preferably used for the water contained in the ink composition of the present embodiment. In particular, the use of water sterilized by irradiation with ultraviolet light or addition of hydrogen peroxide and the like is preferable in terms of allowing long-term storage of the ink composition by preventing the growth of mold and bacteria.

In the present embodiment, “ordinary paper” typically refers to paper used for printers and the like having a pulp as a main raw material thereof that is defined by JIS P 0001 No. 6139, specific examples of which include wood-free paper, PPC copy paper and non-coated printing paper. Ordinary paper available commercially from various manufacturers can be used, examples of which include Xerox 420 (manufactured by Xerox Corp.) and GeoCycle (manufactured by Georgia-Pacific Inc.).

In addition, in the present embodiment, a “recording medium having an absorption layer on a paper support lacking ink absorbency” refers to a recording medium having an absorption layer on a paper support in which the amount of water absorbed within 30 msec^{1/2} from the start of contact in the Bristow method is 30 ml/m² or less. In addition, in the present embodiment, any arbitrary printing coated paper (also referred to as printing paper) conventionally used as printing paper in relief printing, planographic printing (such as offset printing) or intaglio printing (such as gravure printing) can be used. Ordinary coated paper, cast coated paper and matte coated paper are included in this printing coated paper. In addition, printing paper defined in JIS P 0001 No. 6122 and coated paper defined in JIS P 0001 No. 6059 (such as OK Topcoat N) are also included.

A pigment is used for the coloring agent of the ink composition used in the present invention from the viewpoint of light fastness. An inorganic pigment or an organic pigment can be used for the pigment.

Examples of inorganic pigments that can be used include carbon blacks (C.I. Pigment Black No. 7) such as furnace black, lamp black, acetylene black or channel black, iron oxides, and titanium oxides.

In addition, examples of organic pigments include azo pigments such as insoluble azo pigment, condensed azo pigment, azo lake pigment or chelated azo pigment, polycyclic pigments such as phthalocyanine pigment, perylene and perynone pigments, anthraquinone pigment, quinacridone pigment, dioxane pigment, thioindigo pigment, isoindolinone pigment or quinophthalone pigment, dye chelates (such as basic dye chelates or acidic dye chelates), dye lakes (basic dye lakes or acidic dye lakes), nitro pigments, nitoso pigments, aniline black and daylight fluorescent pigments. One type of these pigments can be used alone or two or more types can be used in combination.

The ink composition of the present embodiment is used as a black ink composition or colored ink composition and the like.

Carbon black is preferable for the pigment used in a black ink composition. Specific examples of carbon black include #2300, #900, HCF88, #33, #40, #45, #52, MA7, MA8, MA100 and #2200B manufactured by Mitsubishi Chemical Corp., Raven 5750, 5250, 5000, 3500, 1255 and 700 manufactured by Columbia Corp., Regal 400R, 330R and 660R, Mogul L, Mogul 700, Monarch 800, 880, 900, 1000, 1100, 1300 and 1400 manufactured by Cabot Corp., Color Black FW1, FW2V, FW18 and FW200, Color Black S150, S160, S170, Printex 35, U, V, 140U, and Special Black 6, 5, 4A and 4 manufactured by Degussa AG. One type of these carbon blacks may be used or two or more types may be used as a mixture.

A yellow ink composition, magenta ink composition or cyan ink composition is used for the colored ink composition, and is preferably used in the form of an ink set at least containing a yellow ink composition, magenta ink composition and cyan ink composition. Examples of pigments of colored ink compositions include pigment yellow, pigment red, pigment violet and pigment blue contained in the Color Index.

Specific examples include C.I. Pigment Yellow 1, 3, 12, 13, 14, 17, 24, 34, 35, 37, 42, 53, 55, 74, 81, 83, 95, 97, 98, 100, 101, 104, 108, 109, 110, 117, 120, 128, 138, 147, 150, 153, 155, 174, 180, 188 and 198; C.I. Pigment Red 1, 3, 5, 8, 9, 16, 17, 19, 22, 38 and 57:1, 90, 112, 122, 123, 127, 146, 184, 202, 207, 209; C.I. Pigment Violet 1, 3, 5:1, 16, 19, 23 and 38; C.I. Pigment Blue 1, 2, 15, 15:1, 15:2, 15:3, 15:4 and 16; and C.I. Pigment Black 1 and 7, and an ink composition can also be formed using a plurality of pigments.

In particular, organic pigments contained in the yellow ink composition preferably include at least one type selected from the group consisting of C.I. Pigment Yellow 74, 109, 110, 128, 138, 147, 150, 155, 180 and 188, organic pigments contained in the magenta ink composition preferably include at least one type selected from the group consisting of C.I. Pigment Red 122, 202, 207 and 209 and C.I. Pigment Violet 19, and organic pigments contained in the cyan ink composition preferably include at least one type selected from the group consisting of C.I. Pigment Blue 15, 15:1, 15:2, 15:3, 15:4 and 16.

In addition, a pigment not contained in the Color Index can also be used provided it is insoluble in water.

These pigments are preferably added at 6% by weight or more as solid from the viewpoint of obtaining an adequate printing speed with ordinary paper.

The ink composition of the present embodiment contains a water-soluble organic solvent from the viewpoints of printing quality of an inkjet printer and ensuring reliability in terms of discharge stability, prevention of nozzle clogging and the like.

Examples of water-soluble organic solvents include polyvalent alcohols such as glycerin, 1,2,6-hexanetriol, trimethylolpropane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, 1,5-pentanediol or 4-methyl-1,2-pentanediol; alkyl alcohols having 1 to 4 carbon atoms such as ethanol, methanol, butanol, propanol or isopropanol; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-b-butyl ether, triethylene glycol monobutyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether or dipropylene glycol mono-iso-propyl ether; 2-pyrrolidone, N-methyl-2-pyrrolidone, 1,3-dimethyl-2-imidazolidinone; formaldehyde, acetoamide; dimethylsulfoxide; sorbitol, sorbitan; acetine, diacetine, triacetine; and sulfolane, and one type or two or more types of these solvents can be used.

These water-soluble organic solvents are preferably contained at 10 to 90% by weight in the ink composition from the viewpoints of ensuring suitable physical properties (such as viscosity) of the ink composition and ensuring printing quality and reliability.

In the present embodiment, the water-soluble organic solvent preferably contains at least (b) 15% by weight or more of a polyvalent alcohol monoalkyl ether, having a water vapor pressure at 20° C. of 0.1 mmHg or less, and/or a nitrogen-containing cyclic compound, and (c) a polyvalent alcohol. The use of the water-soluble organic solvent makes it possible to suppress cockling and curling while ensuring printing quality with respect to bleeding, unevenness and the like.

Here, examples of polyvalent alcohol monoalkyl ethers having a water vapor pressure at 20° C. of 0.1 mmHg or less include the previously described glycol ethers such as diethylene glycol monoethyl ether, diethylene glycol monobutyl ether, diethylene glycol monoisobutyl ether, dipropylene glycol monomethyl ether, dipropylene glycol monoisopropyl ether, diisopropylene glycol monobutyl ether, triethylene glycol monomethyl ether, triethylene glycol monobutyl ether, tripropylene glycol monomethyl ether or tripropylene glycol monobutyl ether, while examples of nitrogen-containing cyclic compounds include 1,3-dimethyl-2-imidazolidinone, 2-pyrrolidone and N-methyl-2-pyrrolidone.

In the case of using this water-soluble organic solvent, the weight ratio (a):(b):(c) of the contents of (a) water, (b) polyvalent alcohol monoalkyl ether, having a water vapor pressure at 20° C. of 0.1 mmHg or less, and/or nitrogen-containing cyclic compound, and (c) polyvalent alcohol is preferably 1:0.25 to 8:0.1 to 7, more preferably 1:0.25 to 3.5:0.1 to 0.5, and even more preferably 1:0.25 to 0.5:0.15 to 0.5. If this weight ratio is within the above ranges, an ink composition can be provided having superior reliability with respect to discharge stability, clogging recoverability and the like. This is because polyvalent alcohols are preferable for controlling water retention (moisture retention) and permeability of the ink composition into a recording medium such as ordinary paper, while a polyvalent alcohol monoalkyl ether, having a water vapor pressure at 20° C. of 0.1 mmHg or less, and/or a nitrogen-containing cyclic compound is preferable for controlling discharge stability and permeability of the ink composition into a recording medium, and the combined use thereof within the above weight ratio ranges makes it possible to provide a highly reliable ink composition with respect to printing quality, discharge stability, clogging recoverability and the like.

Here, although any of the previously described polyvalent alcohols can be used for the polyvalent alcohols, 1,2-alkanediols such as 1,2-pentanediol, 1,2-hexanediol or 1,2-octanediol are particularly preferably contained.

A surfactant is contained in the ink composition of the present embodiment from the viewpoint of storage stability. Examples of surfactants that can be contained include anionic surfactants, cationic surfactants, amphoteric surfactants and nonionic surfactants. A nonionic surfactant is particularly preferable from the viewpoint of obtaining an ink composition having low levels of foaming and bubbling.

More specific examples of nonionic surfactants include acetylene glycol-based surfactants, acetylene alcohol-based surfactants, ether-based surfactants such as polyoxyethylene nonyl phenyl ether, polyoxyethylene octyl phenyl ether, polyoxyethylene dodecyl phenyl ether, polyoxyethylene alkyl allyl ether, polyoxyethylene oleyl ether, polyoxyethylene lauryl ether, polyoxyethylene alkyl ether or polyoxyalkylene alkyl ether; ester-based surfactants such as polyoxyethylene oleic acid, polyoxyethylene oleic acid ester, polyoxyethylene stearic acid ester, sorbitan laurate, sorbitan monostearate, sorbitan monooleate, sorbitan sesquioleate, polyoxyethylene monooleate or polyoxyethylene stearate; polyether-modified siloxane-based surfactants such as such as dimethyl polysiloxane; and fluorine-containing surfactants such as fluoroalkyl esters or perfluoroalkyl carboxylic acid salts. One type of nonionic surfactant can be used or two or more types can be used in combination.

Among the above-mentioned nonionic surfactants, acetylene glycol-based surfactants and/or polyether-modified siloxane-based surfactants are particularly preferable in terms of causing little foaming and having superior defoaming performance.

Although more specific examples of acetylene glycol-based surfactants include 2,4,7,9-tetramethyl-5-decyne-4,7-diol, 3,6-dimethyl-4-octyne-3,6-diol and 3,5-dimethyl-1-hexyne-3-ol, these can also be acquired in the form of commercially available products, examples of which include Surfynol 104, 82, 465, 485 or TG manufactured by Air Products Japan, Inc., and Olfine STG or Olfine E1010 manufactured by Nissin Chemical Industry Co., Ltd. More specific examples of polyether-modified siloxane-based surfactants include BYK-345, BYK-346, BYK-347, BYK-348 and UV3530 manufactured by BYK-Chemie Japan K.K. A plurality of types thereof may be used in the ink composition, surface tension is preferably adjusted to 20 to 40 mN/m, and they are contained at 0.1 to 3.0% by weight in the ink composition.

A resin emulsion is contained in the ink composition of the present embodiment from the viewpoints of enhancing the dispersion stability of the pigment and ensuring fixability to a recorded article.

The resin emulsion is preferably a mixture of resin fine particles having a minimum film-forming temperature of 20° C. and above and resin fine particles having a minimum film-forming temperature of below 20° C. The use of a mixture of resin fine particles having a minimum film-forming temperature of 20° C. and above and resin fine particles having a minimum film-forming temperature of below 20° C. for the resin emulsion realizes improvement of fixability and scuff fastness as a result of the resin fine particles having a minimum film-forming temperature of 20° C. and above forming a film at ambient temperatures, as well as high color development on ordinary paper or recycled paper due to the action of the particles remaining on the paper enabling more pigment particles to remain on the paper surface as a result of the resin fine particles having a minimum film-forming temperature of below 20° C. not forming a film at ambient temperatures.

One type of two or more types of resins selected from the group consisting of acrylic resin, methacrylic resin, vinyl acetate resin, vinyl chloride resin and styrene-acrylic resin is preferably used for these resin emulsions. These resins may also be used in the form of homopolymers or copolymers, and those having a single-phase structure or multiphase structure (core-shell types) can also be used.

Moreover, at least one of the two or more types of resin emulsions used in the ink composition of the present embodiment is preferably incorporated in the ink composition in the form of an emulsion of resin fine particles obtained by emulsion polymerization of an unsaturated monomer. This is because the form of the emulsion is preferable in terms of production of the ink composition since the resin fine particles may not be adequately dispersed if added to the ink composition directly. In addition, the emulsion is preferably an acrylic emulsion from the viewpoints of storage stability of the ink composition.

The emulsion of resin fine particles (such as an acrylic emulsion) can be obtained according to a known emulsion polymerization method. For example, the emulsion of resin fine particles can be obtained by emulsion polymerization of an unsaturated monomer (such as an unsaturated vinyl monomer) in water in the presence of a polymerization initiator and surfactant.

Examples of unsaturated monomers include acrylic acid ester monomers, methacrylic acid ester monomers, aromatic vinyl monomers, vinyl ester monomers, vinyl cyan compound monomers, halogenated monomers, olefin monomers and diene monomers ordinarily used in emulsion polymerization. Moreover, specific examples of unsaturated monomers include acrylic acid esters such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate or glycidyl acrylate; methacrylic acid esters such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate or benzyl methacrylate; vinyl esters such as vinyl acetate; vinyl cyan compounds such as acrylonitrile or methacrylonitrile; halogenated monomers such as vinylidene chloride or vinyl chloride; aromatic vinyl monomers such as styrene, α-methylstyrene, vinyltoluene, 4-t-butylstyrene, chlorostyrene, vinylanisole or vinylnaphthalene; olefins such as ethylene or propylene; dienes such as butadiene or chloroprene; vinyl monomers such as vinyl ether, vinyl ketone or vinyl pyrrolidone; unsaturated carboxylic acids such as acrylic acid, methacrylic acid, itaconic acid, fumaric acid or maleic acid; acrylamides such as acrylamide, methacrylamide or N,N-dimethylacrylamide; and hydroxyl group-containing monomers such as 2-hydroxyethylacrylate, 2-hydroxypropylacrylate, 2-hydroxyethylmethacrylate or 2-hydroxypropylmethacrylate, and these can be used alone or two or more types can be used as a mixture.

In addition, a cross-linkable monomer having two or more polymerizable double bonds can also be used. Examples of cross-linkable monomers having two or more polymerizable double bonds include diacrylate compounds such as polyethylene glycol diacrylate, triethylene glycol diacrylate, 1,3-butylene glycol diacrylate, 1,4-butylene glycol diacrylate, 1,6-hexanediol diacrylate, neopentyl glycol diacrylate, 1,9-nonanediol diacrylate, polypropylene glycol diacrylate, 2,2′-bis(4-acryloxypropyloxyphenyl)propane or 2,2′-bis(4-acryloxydiethoxyphenyl)propane; triacrylate compounds such as trimethylol propane triacrylate, trimethylolethane triacrylate or tetramethylol methane triacrylate; tetraacrylate compounds such as ditrimethylol tetraacrylate, tetramethylolmethane tetraacrylate or pentaerythritol tetraacrylate; hexaacrylate compounds such as dipentaerythritol hexaacrylate; dimethacrylate compounds such as ethylene glycol dimethacrylate, diethylene glycol dimethacrylate, triethylene glycol dimethacrylate, polyethylene glycol dimethacrylate, 1,3-butylene glycol dimethacrylate, 1,4-butylene glycol dimethacrylate, 1,6-hexanediol dimethacrylate, neopentyl glycol dimethacrylate, dipropylene glycol dimethacrylate, polypropylene glycol dimethacrylate, polybutylene glycol dimethacrylate or 2,2′-bis(4-methacryloxydiethoxyphenyl) propane; trimethacrylate compounds such as trimethylolpropane trimethacrylate or trimethylolethane trimethacrylate; methylenebisacrylamide; and, divinylbenzene. These can be used alone or two or more types can be used in combination.

In addition to the polymerization initiator and surfactant used in the emulsion polymerization, a chain-transfer agent as well as a neutralizing agent and the like may be used in accordance with ordinary methods. In particular, ammonia, and a hydroxide of an inorganic base, such as sodium hydroxide or potassium hydroxide, are preferably used for the neutralizing agent.

In the present embodiment, from the viewpoint of more effectively obtaining appropriate inkjet physical property values, reliability (with respect to nozzle clogging, discharge stability and the like), high OD value, fixability, glossiness and the like, the advantages of the invention (a high OD value, fixability, and glossiness), the resin emulsion is preferably contained in the ink composition in the range of 1 to 10% by weight.

On the other hand, the volume mean particle diameter of the resin emulsion used in the ink composition is preferably within the range of 20 to 200 nm from the viewpoint of being able to improve dispersion stability in the ink composition, obtain a higher OD value of recorded images, and further improve glossiness.

A pH regulator can be added to the ink composition of the present embodiment. Examples of pH regulators that can be used include alkaline hydroxides such as lithium hydroxide, potassium hydroxide or sodium hydroxide and/or alkanol amines such as ammonia, triethanolamine, tripropanolamine, diethanolamine or monoethanolamine. In particular, at least one type of pH regulator selected from the group consisting of alkaline metal hydroxides, ammonia, triethanolamine and tripropanolamine is preferably contained, and the ink composition is preferably adjusted to pH 6 to 10. If the pH value is within this range, clogging recoverability is maintained without the occurrence of degeneration of materials and the like that compose an inkjet printer.

In addition, collidine, imidazole, phosphoric acid, 3-(N-morpholino)propanesulfonic acid, tris(hydroxymethyl)aminomethane or boric acid and the like may be used as a pH buffer as necessary.

The trialkanolamine can be used also be preferably used as a glossiness imparting agent of the ink composition, and can be added to yellow, magenta and cyan ink compositions to form an image having uniform glossiness on a glossy recording medium.

In addition, the content of the trialkanolamine in the case of using as a glossiness imparting agent of the ink composition is preferably 10 to 50% by weight and more preferably 12 to 45% by weight based on 100% by weight of the pigment, and preferably 1% by weight or more and more preferably no more than 3% by weight and no less than 1% by weight based on the total weight of the ink composition, with respect to erosion of members used in a printer and the viscosity and glossiness of the ink.

Although there are no particular limitations on the trialkanolamine, triethanolamine and/or tripropanolamine are preferable with respect to improving printing stability and glossiness.

Moreover, a surfactant, defoaming agent, antioxidant, ultraviolet absorber, antiseptic or antifungal agents and the like can be added to each of the ink compositions used in the present embodiment as necessary.

Examples of the antioxidants and ultraviolet absorbers include allophanates such as allophanate or methyl allophanate; biurets such as biuret, dimethyl biuret or tetramethyl biuret; L-ascorbic acid and salts thereof; Tinuvin 328, 900, 1130, 384, 292, 123, 144, 622 or 770; Irgacor 252 or 153; Irganox 1010, 1076 or 1035, and MD 1024 manufactured by Nihon Ciba-Geigy K.K.; and lanthanide oxides.

Examples of antiseptic and antifungal agents include sodium benzoate, sodium pentachlorophenol, sodium-2-pyridinethiol-1-oxide, sodium sorbate, sodium dehydroacetate or 1,2-dibenzisothiazolin-3-one (Proxel CRL, Proxel BDN, Proxel GXL, Proxel XL-2 or Proxel TN manufactured by Avecia Limited).

The ink composition of the present embodiment can be prepared in the same manner as a conventional ink composition using a conventionally known apparatus such as a ball mill, sand mill, attritor, basket mill or roll mill. At the time of preparation, it is preferable to remove coarse particles from the viewpoint of preventing nozzle clogging. Removal of coarse particles is carried out by, for example, filtering the ink obtained by mixing each of the above constituents through a filter such as a membrane filter or mesh filter to preferably remove particles having a diameter of 10 μm or more, and more preferably remove those with a diameter of 5 μm or more.

### Inkjet Recording Method

Although the inkjet composition of the present embodiment can be preferably used in writing instruments such as pens or stamps and the like, it can also be preferably used as an ink composition recorded onto a recording medium by an inkjet recording system. An inkjet recording system in the present embodiment refers to a system whereby an ink composition is discharged from fine nozzles in the form of droplets and the droplets are adhered to a recording medium by an inkjet recording apparatus, a detailed explanation of which is provided below.

A first inkjet recording method is an electrostatic suction method in which recording is carried out by applying a strong electric field between nozzles and an acceleration electrode placed in front of the nozzles to continuously spray ink in the form of droplets from the nozzles, and providing a print information signal to deflection electrodes during the time the ink droplets are flying between the deflection electrodes, or by discharging ink droplets according to a print information signal without deflecting the ink droplets.

A second method is a type in which ink droplets are forcibly discharged by applying pressure to an ink liquid with a small pump and mechanically vibrating nozzles with a crystal oscillator. The sprayed ink droplets are charged simultaneous to being sprayed, and a print information signal is imparted to deflection electrodes during the time the ink droplets are flying between the deflection electrodes.

A third method is a type that uses piezoelectric devices in which ink droplets are sprayed to carry out recording by applying pressure to an ink liquid with piezoelectric devices while simultaneously imparting a print information signal to the ink liquid.

A fourth method is a type in which the volume of ink droplets is made to expand rapidly by the action of thermal energy, causing ink droplets to be sprayed to carry out recording by foaming the ink droplets by heating with a microelectrode in accordance with a print information signal.

Any of these methods can be used as an inkjet recording method using the ink composition of the present embodiment.

According to the inkjet recording method of the present embodiment, the use of the previously described ink composition enables conventionally used inkjet recording apparatuses to be used as is without providing additional equipment, while also making it possible to prevent cockling and curling even in the case of using printing coated paper having low water absorbency for the recording medium.

### Recorded Article

A recorded article of the present embodiment is at least that obtained by carrying out recording on a recording medium using the ink composition as described above. As a result of using the previously described ink composition, the recorded article can be used as is without providing additional equipment in a conventionally used inkjet recording apparatus, while also making it possible to prevent cockling and curling even in the case of using printing coated paper having low water absorbency for the recording medium.

### Embodiment B

### Ink Composition

As previously described, the ink composition of embodiment B is at least comprised of a pigment coated with a water-insoluble polymer, a water-soluble organic solvent, a surfactant and 60 to 10% by weight of water. Furthermore, in the present embodiment, the above-mentioned contents are suitably used in the same manner as the previously described Embodiment A.

The water content of the ink composition of the present embodiment is 60 to 10% by weight for the same reasons as in the previously described Embodiment A.

The colorant used in the present embodiment is at least a pigment coated with a water-insoluble polymer, the water-insoluble polymer used in this colorant is composed of a block copolymer resin consisting of a monomer having a hydrophobic group and a monomer having a hydrophilic group, at least contains a monomer having a salt-forming group, and is a polymer for which the solubility thereof in 100 g of water at 25° C. following neutralization is less than 1 g.

Examples of monomers having a hydrophobic group include methacrylic acid esters such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate or glycidyl methacrylate, vinyl esters such as vinyl acetate, vinyl cyan compounds such as acrylonitrile or methacrylonitrile, and aromatic vinyl monomers such as styrene, α-methylstyrene, vinyltoluene, 4-t-butylstyrene, chlorostyrene, vinylanisole or vinylnaphthalene, and these can be used alone or two or more types can be used as a mixture.

Examples of monomers having a hydrophilic group include polyethylene glycol monomethacrylate, polypropylene glycol monomethacrylate and ethylene glycol-propylene glycol monomethacrylate, and each of these can be used alone or two or more types can be used as a mixture. In particular, the use of a monomer component composing a branched chain, such as polyethylene glycol (2 to 30) monomethacrylate, polyethylene glycol (1 to 15)-propylene glycol (1 to 15) monomethacrylate, polypropylene glycol (2 to 30) methacrylate, methoxypolyethylene glycol (2 to 30) methacrylate, methoxypolytetramethylene glycol (2 to 30) methacrylate or methoxy(ethylene glycol-propylene glycol copolymer) (1 to 30) methacrylate, results in improved glossiness of printed images.

Examples of monomers having a salt-forming group include arylic acid, methacrylic acid, styrenecarboxylic acid and maleic acid, and each of these can be used alone or two or more types can be used as a mixture.

Moreover, a macromonomer having a polymerizable functional group on one terminal thereof, such as a styrene-based macromonomer or silicone-based macromonomer, or other monomers, can be used in combination with the monomers described above.

Although the water-insoluble polymer can be obtained by copolymerizing a monomer by a known polymerization method such as bulk polymerization, solution polymerization, suspension polymerization or emulsion polymerization, solution polymerization is particularly preferable. At the time of polymerization, a known radical polymerization agent or polymerization chain transfer agent may be added.

The pigment coated with the water-insoluble polymer can be obtained in the form of an aqueous dispersion by dissolving the water-insoluble polymer in an organic solvent such as methanol, ethanol, isopropanol, n-butanol, acetone, methyl ethyl ketone or dibutyl ether, adding a pigment to the resulting solution, adding a neutralizer and water and carrying out mixing and dispersion treatment to prepare an oil droplet-in-water dispersion, followed by removing the organic solvent from the resulting dispersion. Mixing and dispersion treatment can be carried out using, for example, a ball mill, roll mill, bead mill, high-pressure homogenizer or high-speed agitation-type disperser.

The neutralizer is a tertiary amine such as ethylamine or triethylamine, lithium hydroxide, sodium hydroxide, potassium hydroxide or ammonia and the like, and the pH of the resulting aqueous dispersion is preferably 6 to 10.

In addition, the coating water-insoluble polymer preferably has a weight average molecular weight of about 10000 to 150000 with respect to resulting in stable dispersion of the pigment. Weight average molecular weight can be measured by a molecular weight analysis method using gel permeation chromatography (GPC).

An existing pigment described in “The Dye Guidebook” (publisher: Maruzen Co., Ltd.) can be used as a coloring agent used for the pigment coated with the water-insoluble polymer.

A known inorganic pigment or organic pigment can be used for pigment able to be used in the present embodiment, examples of which include pigments such as pigment yellow, pigment red, pigment violet, pigment blue or pigment black described in the Color Index, and phthalocyanine, azo, anthraquinone, azomethine and condensed ring pigments.

In addition, other examples of pigments include organic pigments such as Yellow No. 4, No. 5, No. 205 or No. 401, Orange No. 228 or No. 405 or Blue No. 1 or No. 404, and inorganic pigments such as titanium oxide, zinc oxide, zirconium oxide, iron oxide, ultramarine, Prussian blue or chromium oxide, and more specifically, C.I. Pigment Yellow 1, 3, 12, 13, 14, 17, 24, 34, 35, 37, 42, 53, 55, 74, 81, 83, 95, 97, 98, 100, 101, 104, 108, 109, 110, 117, 120, 128, 138, 150, 153, 155, 174, 180 and 198, C.I. Pigment Red 1, 3, 5, 8, 9, 16, 17, 19, 22, 38, 57:1, 90, 112, 122, 123, 127, 146, 184, 202 and 209, C.I. Pigment Violet 1, 3, 5:1, 16, 19, 23 and 38, C.I. Pigment Blue 1, 2, 15, 15:1, 15:2, 15:3, 15:4 and 16, and C.I. Pigment Black 1 and 7, and an ink composition can also be formed using a plurality of pigments.

The ink composition of the present embodiment contains a water-soluble organic solvent, surfactant and 60 to 10% by weight of water in the same manner as the above-mentioned Embodiment A.

A pH regulator, pH buffer and glossiness imparting agent in the form of trialkanolamine and the like can be added to the ink composition of the present embodiment in the same manner as the Embodiment A, and a defoaming agent, antioxidant, ultraviolet absorber and antiseptic or antifungal agent and the like can also be added as necessary.

The ink composition of the present embodiment can be prepared in the same manner as a conventional ink composition by using a conventionally known apparatus in the same manner as the Embodiment A.

### Recording Method

The recording method in the present embodiment is a recording method that uses the ink composition of Embodiment B as described above. Examples of recording methods using an ink composition include an inkjet recording method, recording method using a writing instrument such as a pen, and various other types of printing methods. Thus, the ink composition of the above-mentioned embodiment can be preferably used in applications such as a writing instrument such as a water-based pen, inkjet recording method, printing or stamps.

According to another aspect of the recording method of the present embodiment, an inkjet recording method is provided by which printing is carried out by discharging ink droplets of the ink composition of the above-mentioned embodiment and adhering the ink droplets to a recording medium. Any method can be used for the inkjet recording method according to the present embodiment provided the ink composition is discharged from fine nozzles in the form of droplets and the droplets are adhered to a recording medium. Specific examples of such methods include known methods of various aspects similar to that indicated in the above-mentioned Embodiment A.

According to the inkjet recording method of the present embodiment, the use of the ink composition of the Embodiment B enables conventionally used inkjet recording apparatuses to be used as is without providing additional equipment, while also making it possible to prevent cockling and curling even in the case of using printing coated paper having low water absorbency for the recording medium.

### Recorded Article

A recorded article of the present embodiment is at least that obtained by carrying out recording on a recording medium using the ink composition and inkjet recording method of Embodiment B as described above. As a result of using the previously described ink composition and inkjet recording method, this recorded article can be used as is without providing additional equipment in a conventionally used inkjet recording apparatus, while also making it possible to prevent cockling and curling even in the case of using printing coated paper having low water absorbency for the recording medium.

### Embodiment C

### Ink Composition

As previously described, the ink composition of Embodiment C is at least comprised of a self-dispersing pigment, a water-soluble organic solvent, a surfactant and 60 to 10% by weight of water. Furthermore, in the present embodiment, those aspects not described in detail are the same as those of the previously described Embodiment A, and the above-mentioned contents are suitably used in the same manner as the previously described Embodiment A.

The water content of the ink composition of the present embodiment is 60 to 10% by weight for the same reasons as in the previously described Embodiment A.

A self-dispersing pigment is used for the pigment used in the above-mentioned ink composition. A “self-dispersing pigment” refers to a pigment in which a large number of hydrophilic functional groups and/or salts thereof (to be referred to as dispersability-imparting groups) are bonded directly or indirectly through alkyl groups, alkyl ether groups or aryl groups and the like to the pigment surface, and which can be dispersed and/or dissolved in a dispersant and/or aqueous medium. Here, “dispersed and/or dissolved in a dispersant and/or aqueous medium” refers to a state of stably existing a dispersable minimum particle diameter in an aqueous medium without using a dispersant for dispersing the pigment, while a “dispersable minimum particle diameter” refers to a particle diameter of the pigment that does not become any smaller even though dispersion time is increased.

Ink containing the self-dispersing pigment as a coloring agent enable an ink to be easily prepared that is essentially free of foaming caused by dispersants and has superior discharge stability since it is not necessary to contain a dispersant as described above that is ordinarily contained to disperse a pigment. In addition, since large increases in viscosity attributable to dispersants can be suppressed, it becomes possible to contain a larger amount of pigment, thereby facilitating greater ease of handling by making it possible to adequately enhance print density and the like.

The self-dispersing pigment is produced by, for example, bonding (grafting) a dispersability-imparting group, such as —COOH, —CO, —OH, —SO₃H, —PO₃H, quanternary ammonium or salts thereof, or active species having these dispersability-imparting groups, to the surface of the pigment by carrying out physical treatment or chemical treatment on the pigment. An example of the physical treatment is vacuum plasma treatment. In addition, examples of the chemical treatment include wet oxidation, in which the pigment surface is oxidized by an oxidizing agent in water, and a method in which carboxyl groups are bonded through phenyl groups by bonding p-aminobenzoic acid to the pigment surface.

In the present embodiment, a self-dispersing pigment subjected to surface treatment consisting of oxidation treatment with a hypohalous acid and/or hypohalite or oxidation treatment with ozone is preferable with respect to high color development.

The volume mean particle diameter of the self-dispersing pigment is preferably 50 to 250 nm from the viewpoints of being able to further enhance dispersion stability in the ink composition and the OD values of recorded images as well as further improve glossiness. Furthermore, these volume mean particle diameters can be obtained by measuring particle diameter with the Microtrac UPA150 (manufactured by Microtrac, Inc.) or LPA3100 particle size distribution measuring system (manufactured by Otsuka Electronics Co., Ltd.).

An inorganic pigment or organic pigment can be used for the pigment used in the self-dispersing pigment, specific examples of which include the same pigments used in the previously described Embodiment A.

In addition, a commercially available product can also be used for the self-dispersing pigment, examples of which include Microjet CW-1 (trade name, manufactured by Orient Chemical Industries, Ltd.), CAB-O-JET 200, CAB-O-JET 250C, CAB-O-JET 260M, CAB-O-JET 270Y and CAB-O-JET 300 (trade names, manufactured by Cabot Corp.).

The ink composition of the present embodiment contains a water-soluble organic solvent, surfactant and 60 to 10% by weight of water in the same manner as the above-mentioned Embodiment A.

A pH regulator, pH buffer and glossiness imparting agent in the form of trialkanolamine and the like can be added to the ink composition of the present embodiment in the same manner as the Embodiment A, and a defoaming agent, antioxidant, ultraviolet absorber and antiseptic or antifungal agent and the like can also be added as necessary.

The ink composition of the present embodiment can be prepared in the same manner as a conventional ink composition by using a conventionally known apparatus in the same manner as the Embodiment A.

### Inkjet Recording Method

The recording method in the present embodiment is a recording method that uses the ink composition of Embodiment C as described above. Although the ink composition of the present embodiment can be preferably used in a writing instrument such as a pen or in a stamp, it can be preferably used as an ink composition recorded onto a recording medium with an inkjet recording system in the same manner as the previously described Embodiment A.

According to the inkjet recording method of the present embodiment, the use of the ink composition of the Embodiment C enables conventionally used inkjet recording apparatuses to be used as is without providing additional equipment, while also making it possible to prevent cockling and curling even in the case of using printing coated paper having low water absorbency for the recording medium.

### Recorded Article

A recorded article of the present embodiment is at least that obtained by carrying out recording on a recording medium using the ink composition of Embodiment C as described above. As a result of using the previously described ink composition, this recorded article can be used as is without providing additional equipment in a conventionally used inkjet recording apparatus, while also making it possible to prevent cockling and curling even in the case of using printing coated paper having low water absorbency for the recording medium.

### EXAMPLE A

### 1. Preparation of Pigment Dispersion

### (1) Preparation of Magenta Pigment Dispersion M2

65 g of an organic pigment in the form of C.I. Pigment Red 122, 35 g of a styrene-acrylic acid-based dispersed resin having carboxylic acid groups for the anionic groups in the form of Johncryl 611 (Johnson Polymer Co., Ltd., average molecular weight: 8100, acid value: 53 KOH mg/g), 1.70 g of potassium hydroxide and 250 g of ultrapure water purified by ion exchange or reverse osmosis treatment were mixed followed by dispersing for 10 hours with a ball mill using zirconia beads. The resulting raw dispersion was passed through a membrane filter having a pore size of about 8 μm (Nippon Millipore, Ltd.) followed by removal of coarse particles and diluting with ultrapure water to a pigment concentration of 50% by weight to prepare the pigment dispersion M2.

### 2. Preparation of Ink Compositions

Ink compositions containing pigment, water-soluble organic solvent, resin emulsion, surfactant and water were prepared according to the combinations indicated in Table 1.

Furthermore, a mixture of resin fine particles having a minimum film-forming temperature (MFT) of below 20° C. and resin fine particles having an MFT of 20° C. and above was used for the resin emulsion.

Resin fine particles having an MFT of below 20° C. were produced by polymerizing 600 g of methyl methacrylate, 125 g of butyl acrylate, 30 g of methacrylic acid and 5 g of triethylene glycol diacrylate with 20 g of acrylamide. The resulting resin fine particles were confirmed to not form a film under temperature conditions of 20° C.

Resin fine particles having an MFT of 20° C. and above were produced by polymerizing 130 g of styrene, 780 g of 2-ethylhexyl acrylate, 30 g of methacrylic acid and 2 g of ethylene glycol dimethacrylate with 20 g of acrylamide. The resulting resin fine particles were confirmed to form a film under temperature conditions of 20° C.

TABLE 1

| | | Examples | | | | |
|---|---|---|---|---|---|---|
| Ink Compositions | | 1 | 2 | 3 | 4 | 5 |
| Pigment dispersion | M2 | 12 | 12 | 10 | 14 | 12 |
| Polyvalent alcohol | TEGmBE | 55.8 | 61.9 | 56.35 | 24.85 | 70.85 |
| monoalkyl ether or | | | | | | |
| nitrogen-containing | | | | | | |
| solvent (b) | | | | | | |
| Polyvalent alcohol (c) | 1,2-HD | 15 | 10 | 15 | 15 | 10 |
| Surfactant | Surfynol | 0.2 | 0.1 | 0.15 | 0.15 | 0.15 |
| | 104 | | | | | |
| Resin emulsion | MFT < 20° C. | 2 | 2 | 2 | 2 | 2 |
| | MFT ≧ 20° C. | 1 | 0 | 1.5 | 1 | 1 |

| | | | | | |
|---|---|---|---|---|---|
| Water (a) | 20 | 20 | 20 | 50 | 10 |
| Total | 100 | 100 | 100 | 100 | 100 |
| (a):(b):(c) | 1:2.79:0.75 | 1:3.10:0.50 | 1:2.82:0.75 | 1:0.50:0.30 | 1:7.09:1.00 |

| | | | | Comparative | |
|---|---|---|---|---|---|
| | | Examples | | Examples | |
| Ink Compositions | | 6 | 7 | 1 | 2 |
| Pigment dispersion | M2 | 14 | 12 | 12 | 14 |
| Polyvalent alcohol | TEGmBE | 34.85 | 20.85 | 80.85 | 25 |
| monoalkyl ether or | | | | | |
| nitrogen-containing | | | | | |
| solvent (b) | | | | | |
| Polyvalent alcohol (c) | 1,2-HD | 5 | 10 | 10 | 15 |
| Surfactant | Surfynol | 0.15 | 0.15 | 0.15 | 0 |
| | 104 | | | | |
| Resin emulsion | MFT < 20° C. | 2 | 2 | 2 | 2 |
| | MFT ≧ 20° C. | 1 | 1 | 1 | 1 |

| | | | | |
|---|---|---|---|---|
| Water (a) | 50 | 60 | 6 | 50 |
| Total | 100 | 100 | 100 | 100 |
| (a):(b):(c) | 1:0.70:0.10 | 1:0.35:0.17 | 1:13.5:1.67 | 1:0.50:0.30 |

1,2-HD: 1,2-hexanediol
TEGmBE: Triethylene glycol monobutyl ether
Surfynol 104: Air Products Japan, Inc.

### 2. Evaluation Tests

### (1) Printing Method

The ink compositions indicated in Table 1 (Examples 1 to 7 and Comparative Examples 1 and 2) were filled into the PX-A550 Inkjet Printer (manufactured by Seiko Epson Corp.) and a magenta patch pattern was printed onto recording media at a duty factor of 100%. A type of printing paper (printing coated paper) in the form of OK Topcoat N (manufactured by Oji Paper Co., Ltd.) and a type of ordinary paper in the form of Xerox P (manufactured by Fuji Xerox Co., Ltd.) and Xerox 4024 (manufactured by Xerox Corp.) were used for the recording media. The resulting patch patterns were then used as samples for each of the evaluation tests described below.

### (2) Evaluation of Optical Density (OD Value)

The OD values of the patch areas were measured using a Gretag densitometer (manufactured by GretagMacbeth Inc.). The mean value was determined for each sample, and optical density (OD) was evaluated using the following evaluation criteria based on the calculated mean OD values. Those results are shown in Table 2.

A: 1.2 or more

B: 1.0 to 0.9

C: Less than 0.9

### (3) Evaluation of Printing Quality

The image quality of each sample was observed visually and evaluated using the following evaluation criteria. Those results are shown in Table 2.

A: Good color development and no color unevenness

B: Slight color unevenness, but not a problem in terms of practical use

C: Conspicuous color unevenness preventing practical use

### (4) Evaluation of Cockling

Surface irregularities (cockling) were measured for each sample using a laser displacement gauge (LK-010, manufactured by Keyence Corp.). The mean value was determined for each sample, and cockling was evaluated using the following evaluation criteria based on the calculated mean value. Those results are shown in Table 2.

A: Surface irregularities of less than 1.0 mm

B: Surface irregularities of 1.0 to 2.0 mm

C: Surface irregularities of 2.0 mm or more

### (5) Fixability (Drying)

After allowing each sample to air dry overnight following printing, the printed area of the samples was rubbed with a finger followed by visually observing the status of the printed surface and any ink adhering to the finger. The results were evaluated based on the following criteria. Those results are shown in Table 2.

A: No change in printed surface and no adhesion of ink to finger B: Slight loss of ink from printed surface but no adhesion of ink to finger C: Conspicuous loss of ink from printed surface and ink adhered to finger

TABLE 2

| | | | | | | | | Comparative | |
|---|---|---|---|---|---|---|---|---|---|
| Evaluation | Examples | | | | | | | Examples | |
| Parameters | 1 | 2 | 3 | 4 | 5 | 6 | 7 | 1 | 2 |
| Optical density | A | B | B | A | A | B | A | A | B |
| (OD value) | | | | | | | | | |
| Printing quality | A | A | B | A | A | B | A | A | C |
| Cockling | A | A | A | B | A | B | C | A | B |
| Fixability | A | A | A | A | B | B | A | C | C |

### EXAMPLE B

### 1. Synthesis of Water-Insoluble Polymer

A pigment dispersion using a pigment coated with a water-insoluble polymer for the dispersed particles (resin dispersed pigment) was prepared according to the method described below.

20 parts by weight of an organic solvent (methyl ethyl ketone), 0.03 parts by weight of a polymerization chain transfer agent (2-mercaptoethanol), a polymerization initiator and each of the monomers indicated in Table 3 were polymerized while stirring at 75° C. in a reaction vessel in which the atmosphere had been adequately replaced with nitrogen gas, followed by the addition of 0.9 parts by weight of 2,2′-azobis(2,4-dimethylvaleronitrile) dissolved in 40 parts by weight of methyl ethyl ketone to 100 parts by weight of the monomer component and aging for 1 hour at 80° C. to obtain a polymer solution. Furthermore, the values shown in Table 3 indicate the proportion (percent by weight) of each monomer based on the total amount of monomer mixture (100%).

TABLE 3

| | Water-Insoluble |
|---|---|
| Composition of Monomer Mixture | Polymer (wt %) |
| Polypropylene glycol monomethacrylate (PO = 9) | 15 |
| Poly(ethylene glycol-propylene glycol) | 15 |
| monomethacrylate (EO = 5, PO = 7) | |
| Methacrylic acid | 12 |
| Styrene monomer | 40 |
| Styrene macromer | 15 |
| Benzyl methacrylate | 10 |

EO: Ethylene oxide
PO: Propylene oxide

### 2. Preparation of Pigment Dispersion

### (1) Preparation of Yellow Pigment Dispersion Y1

7.5 parts by weight of a water-insoluble monomer of Table 1 were dissolved in 45 parts by weight of methyl ethyl ketone followed by the addition of a prescribed amount of 20% aqueous sodium hydroxide solution (neutralizer) thereto to neutralize salt forming groups, and the further addition of 20 parts by weight of pigment in the form of C.I. Pigment Yellow 74 and mixing for 2 hours with a bead mill. 120 parts by weight of ion exchange water were added to the resulting mixture followed by stirring, removing the methyl ethyl ketone at 60° C. under reduced pressure and further removing a portion of the water to obtain the yellow pigment dispersion Y1 having a solid concentration of 20% by weight.

### (2) Preparation of Magenta Pigment Dispersion M1

Magenta pigment dispersion M1 having a solid concentration of 20% by weight was obtained in the same manner as yellow pigment dispersion Y1 above with the exception of dissolving 5 parts by weight instead of 7.5 parts by weight of water-insoluble polymer of Table 1 in 45 parts by weight of methyl ethyl ketone, and using 20 parts by weight of C.I. Pigment Violet 19 instead of 20 parts by weight of C.I. Pigment Yellow 74 as pigment.

### (3) Preparation of Cyan Pigment Dispersion C1

Cyan pigment dispersion C1 having a solid concentration of 20% by weight was obtained in the same manner as yellow pigment dispersion Y1 above with the exception of using 12.5 parts by weight instead of 7.5 parts by weight of the water-insoluble polymer of Table 1, and using 12.5 parts by weight of C.I. Pigment Blue 15:4 instead of 20 parts by weight of C.I. Pigment Yellow 74 as pigment.

### (4) Black Pigment Dispersion K1

Black pigment dispersion K1 having a solid concentration of 20% by weight was obtained in the same manner as yellow pigment dispersion Y1 above with the exception of using 15 parts by weight instead of 7.5 parts by weight of the water-insoluble polymer of Table 1, and using 25 parts by weight of C.I. Pigment Black 7 (carbon black) instead of 20 parts by weight of C.I. Pigment Yellow 74 as pigment.

### (5) Preparation of Cyan Pigment Dispersion C2

20 parts by weight of a water-insoluble monomer of Table 1 were dissolved in 90 parts by weight of methyl ethyl ketone followed by the addition of a prescribed amount of 20% aqueous sodium hydroxide solution (neutralizer) thereto to neutralize salt forming groups, and the further addition of 40 parts by weight of pigment in the form of C.I. Pigment Blue 15:4 and mixing for 2 hours with a bead mill. 120 parts by weight of ion exchange water were added to the resulting mixture followed by stirring, removing the methyl ethyl ketone at 60° C. under reduced pressure and concentrating to obtain the cyan pigment dispersion C2 having a solid concentration of 50% by weight.

### 3. Preparation of Ink Compositions

Each of the pigment dispersions prepared as described above (Y1, M1, C1, K1 and C2), each of the solvents and ultrapure water were mixed at the mixing ratios (wt %) shown in the following Table 4 followed by stirring for 2 hours. Continuing, the mixtures were filtered using a membrane filter having a pore size of about 8 μm (trade name, manufactured by Nippon Millipore, Ltd.) to prepare the ink compositions of Examples 1 to 6 and Comparative Examples 1 to 4. Furthermore, the values shown in Table 4 are indicated in percent by weight (wt %).

TABLE 4

| | | Examples | | | | | |
|---|---|---|---|---|---|---|---|
| Ink Compositions | | 1 | 2 | 3 | 4 | 5 | 6 |
| Resin dispersed | C1 | 40 | | | | | |
| pigment dispersion | M1 | | 35 | | | | |
| | Y1 | | | 40 | | | 25 |
| | K1 | | | | 30 | | |
| | C2 | | | | | 20 | |
| Polyvalent alcohol | TEGmBE | 36.8 | 17.8 | 26.8 | 24.8 | 59.8 | 19.8 |
| monoalkyl ether or | | | | | | | |
| nitrogen-containing | | | | | | | |
| solvent (b) | | | | | | | |
| Polyvalent alcohol (c) | 1,2-HD | 15 | 15 | 5 | 15 | 15 | 15 |
| Surfactant | Surfynol | 0.2 | 0.2 | 0.2 | 0.2 | 0.2 | 0.2 |
| | 104 | | | | | | |

| | | | | | | |
|---|---|---|---|---|---|---|
| Water (a) | 40 | 60 | 60 | 50 | 15 | 60 |
| Total | 100 | 100 | 100 | 100 | 100 | 100 |
| (a):(b):(c) | 1:0.92:0.38 | 1:0.30:0.25 | 1:0.45:0.08 | 1:0.50:0.30 | 1:3.99:1.00 | 1:0.33:0.25 |

| | | Comparative Examples | | | |
|---|---|---|---|---|---|
| Ink Compositions | | 1 | 2 | 3 | 4 |
| Resin dispersed | C1 | 40 | | | |
| pigment dispersion | M1 | | 35 | | |
| | Y1 | | | | |
| | K1 | | | 40 | |
| | C2 | | | | 16 |
| Polyvalent alcohol | TEGmBE | 6.8 | 18.0 | 16.8 | 68.8 |
| monoalkyl ether or | | | | | |
| nitrogen-containing | | | | | |
| solvent (b) | | | | | |
| Polyvalent alcohol (c) | 1,2-HD | 15 | 15 | 5 | 15 |
| Surfactant | Surfynol | 0.2 | 0 | 0.2 | 0.2 |
| | 104 | | | | |

| | | | | |
|---|---|---|---|---|
| Water (a) | 70 | 60 | 70 | 8 |
| Total | 100 | 100 | 100 | 100 |
| (a):(b):(c) | 1:0.10:0.21 | 1:0.30:0.25 | 1:0.24:0.07 | 1:8.60:1.88 |

1,2-HD: 1,2-hexanediol
TEGmBE: Triethylene glycol monobutyl ether

### 3. Evaluation Tests

### (1) Printing Method

Patch patterns were printed at a duty factor of 100% on recording media with the PX-A550 Inkjet Printer (Seiko Epson Corp.) using the ink compositions shown in Table 2. A type of printing paper (printing coated paper) in the form of OK Topcoat N (manufactured by Oji Paper Co., Ltd.) and a type of ordinary paper in the form of Xerox P (manufactured by Fuji Xerox Co., Ltd.) and Xerox 4200 (manufactured by Xerox Corp.) were used for the recording media. The resulting patch patterns were then used as samples for each of the evaluation tests described below.

### (2) Evaluations

Optical density (OD value), printing quality, cockling and fixability (drying) were evaluated in the same manner as in Example A. Those results are shown in Table 5.

TABLE 5

| Evaluation | Examples | | | | | | Comparative Examples | | | |
|---|---|---|---|---|---|---|---|---|---|---|
| Parameters | 1 | 2 | 3 | 4 | 5 | 6 | 1 | 2 | 3 | 4 |
| Optical density | A | A | B | B | A | C | A | B | B | A |
| (OD value) | | | | | | | | | | |
| Printing quality | A | A | B | B | B | B | B | C | B | B |
| Cockling | A | B | B | A | A | B | C | B | C | A |
| Fixability | A | A | A | A | B | A | A | B | A | C |

As previously explained, an ink composition of the present example enables conventionally used inkjet recording apparatuses to be used as is without adding additional equipment, while also improving printability on recording media having low ink absorbency. More specifically, these ink compositions have superior optical density, printing quality and fixability while also suppressing cockling and curling.

### EXAMPLE C

### 1. Preparation of Pigment Dispersion

100 g of a commercially available carbon black in the form of S170 (trade name, manufactured by Degussa AG) were mixed in 500 g of water and crushed with a ball mill using zirconia beads. 500 g of sodium hypochlorite (effective chlorine concentration: 12%) were dropped into this raw crushing liquid followed by boiling for 10 hours while stirring to carry out wet oxidation. The resulting raw dispersion was filtered with GA-100 Glass Fiber Filter Paper (trade name, manufactured by Advantec Toyo Kaisha Ltd.) followed by further washing with water. The resulting wet cake was redispersed in 5 kg of water, desalted and purified with a reverse osmosis membrane to an electrical conductivity of 2 mS/cm, and then further concentrated to a pigment concentration of 50% by weight to prepare a self-dispersing pigment dispersion B1 using a self-dispersing pigment for the dispersed particles.

### 2. Preparation of Ink Compositions

Ink compositions were prepared containing self-dispersing pigment dispersion, water-soluble organic solvent, resin emulsion, surfactant and water in the combinations indicated in Tables 6 and 7. The ink compositions were prepared by mixing each of the components at the mixing ratios shown in Table 1 and stirring the mixture for 2 hours followed by filtering with a stainless steel filter having a pore size of about 5 μm. Furthermore, the values shown in Tables 6 and 7 are indicated in percent by weight (wt %).

TABLE 6

| | | Examples | | | | | |
|---|---|---|---|---|---|---|---|
| Ink Compositions | | 1 | 2 | 3 | 4 | 5 | 6 |
| Self-dispersing | B1 | 20 | | 20 | | | 20 |
| pigment dispersion | CAB-O-JET250C | | 60 | | | | |
| | CAB-O-JET260M | | | | 60 | | |
| | CAB-O-JET270Y | | | | | 60 | |
| Polyvalent alcohol | TEGmBE | 47.8 | 11.85 | 52.85 | 24.9 | 21.85 | 62.85 |
| monoalkyl ether or | | | | | | | |
| nitrogen-containing | | | | | | | |
| solvent (b) | | | | | | | |
| Polyvalent alcohol (c) | 1,2-HD | 15 | 15 | 15 | 10 | 5 | 10 |
| Surfactant | Surfynol 104 | 0.2 | 0.15 | 0.15 | 0.1 | 0.15 | 0.15 |
| Resin emulsion | Polymer 1 | 5 | 5 | 0 | 5 | 5 | 5 |
| | Polymer 2 | 2 | 2 | 2 | 0 | 2 | 5 |

| | | | | | | |
|---|---|---|---|---|---|---|
| Water (a) | 20 | 60 | 20 | 54 | 60 | 10 |
| Total | 100 | 100 | 100 | 100 | 100 | 100 |
| (a):(b):(c) | 1:2.39:0.75 | 1:0.20:0.25 | 1:2.64:0.75 | 1:0.46:0.19 | 1:0.36:0.08 | 1:6.29:1.00 |

CAB-O-JET250C, CAB-O-JET260M, CAB-O-JET270Y: Self-dispersing pigments manufactured by Cabot Corp. (pigment solid fraction: 10% by weight)
1,2-HD: 1,2-hexanediol
TEGmBE: Triethylene glycol monobutyl ether
Surfynol 104: Surfactant manufactured by Air Products Japan, Inc.

TABLE 7

| | | Comparative Examples | | | | |
|---|---|---|---|---|---|---|
| Ink Compositions | | 1 | 2 | 3 | 4 | 5 |
| Self-dispersing pigment dispersion | B1 | | 16 | 16 | | |
| | CAB-O-JET250C | 60 | | | | |
| | CAB-O-JET260M | | | | 60 | |
| | CAB-O-JET270Y | | | | | 60 |
| Polyvalent alcohol monoalkyl | TEGmBE | 6.85 | 58.85 | 60.85 | 12 | 11.85a |
| ether or nitrogen- | | | | | | |
| containing solvent (b) | | | | | | |
| Polyvalent alcohol (c) | 1,2-HD | 10 | 10 | 10 | 15 | 10 |
| Surfactant | Surfynol 104 | 0.15 | 0.15 | 0.15 | 0 | 0.15 |
| Resin emulsion | Polymer 1 | 5 | 5 | 5 | 5 | 0 |
| | Polymer 2 | 2 | 2 | 0 | 2 | 2 |

| | | | | | |
|---|---|---|---|---|---|
| Water (a) | 70 | 8 | 8 | 60 | 70 |
| Total | 100 | 100 | 100 | 100 | 100 |
| (a):(b):(c) | 1:0.10:0.14 | 1:7.36:1.25 | 1:7.61:1.25 | 1:0.20:0.25 | 1:0.17:0.14 |

CAB-O-JET250C, CAB-O-JET260M, CAB-O-JET270Y: Self-dispersing pigments manufactured by Cabot Corp. (pigment solid fraction: 10% by weight)
1,2-HD: 1,2-hexanediol
TEGmBE: Triethylene glycol monobutyl ether
Surfynol 104: Surfactant manufactured by Air Products Japan, Inc.

Furthermore, the resin emulsions were synthesized using a flask equipped with a stirrer, nitrogen feed tube, condenser and two dropping funnels. Emulsions obtained by emulsifying mixtures having the compositions shown in Table 8 were placed in one of the two dropping funnels, and a solution in which 0.3 parts of a catalyst in the form of potassium persulfate were dissolved in 5 parts of water was placed in the other dropping funnel. 0.2 parts of sodium lauryl sulfate were dissolved in 190 parts of water in the flask, and the atmosphere in the flask was replaced with a nitrogen atmosphere. Next, the solution in the flask was heated to 70° C. with a hot water bath, and the solutions in the dropping funnels were dropped into the solution in the flask over the course of 4 hours while stirring at 250 rpm to carry out the reaction. Following completion of dropping, stirring was continued for an additional 4 hours. After the reaction liquid cooled, the reaction liquid was neutralized in aqueous sodium hydroxide solution to obtain polymer particles having a non-volatile component content of 30%.

Table 8 shows the proportions (wt %) of each monomer based on the total weight of the resin emulsion (100%). In addition, the results of measuring the mean particle diameters and minimum film-forming temperatures (MFT) of the polymer particles are also shown in Table 8. Furthermore, the mean particle diameters of the polymer particles were measured using the N4 Coulter Counter (trade name, manufactured by Coulter Electronics Ltd.).

TABLE 8

| Composition of Resin Emulsion | Polymer 1 | Polymer 2 |
|---|---|---|
| Styrene | 40.0 | 61.5 |
| Butyl acrylate | 52.0 | 29.5 |
| Acrylamide | 1.0 | 2.0 |
| Polyethylene glycol dimethacrylate | 2.0 | — |
| Methacrylic acid | 5.0 | 5.0 |
| Sodium lauryl sulfate | 0.3 | 0.3 |
| Ultrapure water | 44.0 | 45.0 |
| Mean particle diameter (nm) | 50 | 130 |
| MFT (° C.) | 10 | 36 |

### 3. Evaluation Tests

### (1) Printing Method

The ink compositions indicated in Tables 1 and 2 were filled into the PX-A550 Inkjet Printer (manufactured by Seiko Epson Corp.) and patch patterns were printed onto recording media at a duty factor of 100%. A type of printing paper (printing coated paper) in the form of OK Topcoat N (manufactured by Oji Paper Co., Ltd.) and a type of ordinary paper in the form of Xerox P (manufactured by Fuji Xerox Co., Ltd.) and Xerox 4200 (manufactured by Xerox Corp.) were used for the recording media. The resulting patch patterns were then used as samples for each of the evaluation tests described below.

### (2) Evaluations

Optical density (OD value), printing quality, cockling and fixability (drying) were evaluated in the same manner as in Example A. Those results are shown in Tables 9 and 10.

TABLE 9

| | |
|---|---|
| Evaluation | Examples |

| Parameters | 1 | 2 | 3 | 4 | 5 | 6 |
|---|---|---|---|---|---|---|
| Optical | A | A | A | B | B | A |
| density (OD | | | | | | |
| value) | | | | | | |
| Printing | A | A | B | A | B | A |
| quality | | | | | | |
| Cockling | A | B | A | A | B | A |
| Fixability | A | A | B | A | B | B |

TABLE 10

| Evaluation | Comparative Examples | | | | |
|---|---|---|---|---|---|
| Parameters | 1 | 2 | 3 | 4 | 5 |
| Optical | A | A | B | B | A |
| density (OD | | | | | |
| value) | | | | | |
| Printing | A | A | A | C | A |
| quality | | | | | |
| Cockling | C | A | A | B | C |
| Fixability | A | C | C | C | B |

As previously explained, as a result of an ink composition of the present example consisting of an ink composition comprising a self-dispersing pigment, water-soluble inorganic solvent, surfactant and 60 to 10% by weight of water, it is able to improve printability on recording media having low ink absorbency. More specifically, these ink compositions have superior optical density, printing quality and fixability while also suppressing cockling and curling.

### EXAMPLE D

### 1. Preparation of Ink Compositions

The pigment dispersion M2 prepared in Example A, each of the pigment dispersions prepared in Example B (Y1, M1C1, K1 and C2) and the pigment dispersion B1 prepared in Example C, along with each solvent, resin emulsion and ultrapure water, were mixed at the mixing ratios (wt %) shown in the following Table 11 and stirred for 2 hours. Continuing, the mixtures were filtered using a membrane filter having a pore size of about 8 μm (trade name, Nippon Millipore, Ltd.) to prepare the ink compositions of Examples 1 to 9 and Comparative Examples 1 to 5. Furthermore, the values shown in Table 11 are indicated in percent by weight (wt %).

Furthermore, a mixture of resin fine particles having an MFT of below 20° C. and resin fine particles having an MFT of 20° C. and above produced in Example A were used for the resin emulsion.

TABLE 11

| | | Examples | | | | | | | | |
|---|---|---|---|---|---|---|---|---|---|---|
| Ink Compositions | | 1 | 2 | 3 | 4 | 5 | 6 | 7 | 8 | 9 |
| Pigment | C1 | | | | | 40 | | | | 30 |
| dispersion | M1 | 35 | 35 | 30 | 35 | | | | | |
| | Y1 | | | | | | 40 | | | |
| | C2 | | | | | | | | 12 | |
| | K1 | | | | | | | | | |
| | B1 | | | | | | | 12 | | |
| Polyvalent | Triethylene glycol | 24.85 | | 20.85 | 34.85 | 36.8 | 26.8 | 55.8 | 73.85 | 11.85 |
| alcohol | monobutyl ether | | | | | | | | | |
| monoalkyl | 2-pyrrolidone | | 24.85 | | | | | | | |
| ether or | | | | | | | | | | |
| nitrogen- | | | | | | | | | | |
| containing | | | | | | | | | | |
| solvent (b) | | | | | | | | | | |
| Polyvalent | 1,2-hexanediol | 15 | 15 | 10 | 5 | 15 | 5 | 15 | 10 | 15 |
| alcohol (c) | | | | | | | | | | |
| Surfactant | Surfynol 104 | 0.15 | 0.15 | 0.15 | 0.15 | 0.2 | 0.2 | 0.2 | 0.15 | 0.15 |
| Resin emulsion | MFT < 20° C. | 2 | 2 | 2 | 2 | | | 2 | | 5 |
| | MFT ≧ 20° C. | 1 | 1 | 1 | 1 | | | 1 | | 2 |

| | | | | | | | | | |
|---|---|---|---|---|---|---|---|---|---|
| Water (a) | 50 | 50 | 60 | 50 | 40 | 60 | 20 | 10 | 60 |
| Total | 100 | 100 | 100 | 100 | 100 | 100 | 100 | 100 | 100 |
| (a):(b):(c) | 1:0.5:0.3 | 1:0.5:0.3 | 1:0.35:0.17 | 1:0.7:0.1 | 1:0.92:0.38 | 1:0.45:0.08 | 1:2.79:0.75 | 1:7.39:1 | 1:0.2:0.25 |

| | | Comparative Examples | | | | |
|---|---|---|---|---|---|---|
| Ink Compositions | | 1 | 2 | 3 | 4 | 5 |
| Pigment dispersion | C1 | | | 40 | | |
| | M1 | | | | | 35 |
| | Y1 | | | | | |
| | C2 | 16 | | | | |
| | K1 | | 40 | | 40 | |
| | B1 | | | | | |
| Polyvalent alcohol monoalkyl ether or | Triethylene glycol monobutyl | 68.8 | 16.8 | 6.8 | 21.8 | 25 |
| nitrogen-containing solvent (b) | ether | | | | | |
| | 2-pyrrolidone | | | | | |
| Polyvalent alcohol (c) | 1,2-hexanediol | 15 | 5 | 15 | 5 | 15 |
| Surfactant | Surfynol 104 | 0.2 | 0.2 | 0.2 | 0.2 | 0 |
| Resin emulsion | MFT < 20° C. | | | | | 2 |
| | MFT ≧ 20° C. | | | | | 1 |

| | | | | | |
|---|---|---|---|---|---|
| Water (a) | 8 | 70 | 70 | 65 | 50 |
| Total | 100 | 100 | 100 | 100 | 100 |
| (a):(b):(c) | 1:8.6:1.88 | 1:0.24:0.07 | 1:0.1:0.21 | 1:0.34:0.08 | 1:0.5:0.3 |

### 2. Evaluation Tests

### (1) Printing Method

Patch patterns were printed at a duty factor of 100% on recording media with the PX-A550 Inkjet Printer (Seiko Epson Corp.) using the ink compositions shown in Table 11. A type of printing paper (printing coated paper) in the form of OK Topcoat N (manufactured by Oji Paper Co., Ltd.) and a type of ordinary paper in the form of Xerox P (manufactured by Fuji Xerox Co., Ltd.) and Xerox 4200 (manufactured by Xerox Corp.) were used for the recording media. The resulting patch patterns were then used as samples for each of the evaluation tests described below.

Next, (2) optical density (OD value), (3) printing quality, (4) cockling and (5) fixability (drying) were evaluated in the same manner as in Example A. Furthermore, cockling was evaluated while changing a portion of the evaluation criteria as indicated below. Those results are shown in Table 12.

### (4) Cockling Evaluation Criteria

AA: Surface irregularities of less than 1.0 mm

A: Surface irregularities of 1.0 mm to less than 1.6 mm

B: Surface irregularities of 1.6 mm to less than 2.2 mm

C: Surface irregularities of 2.2 mm or more

In addition, discharge stability and clogging recovery were also evaluated in addition to the evaluations described above. Those results are shown in Table 12.

### (6) Evaluation of Discharge Stability

Each of the prepared ink compositions was filled into the PX-A550 Inkjet Printer and patterns containing solid areas and lined areas were printed continuously in an environment at 40° C. In the case disturbances in printing occurred caused by nozzle separation or curvature of the flying ink during printing, a reset operation (cleaning) provided with the recording apparatus was carried out as the situation required. The number of times the above-mentioned required cleaning was carried out within 100 pages of continuous printing was measured, and those results were evaluated based on the following criteria.

A: Cleaning not required

B: 3 rounds of cleaning or less were required

C: 3 or more rounds of cleaning were required

### (7) Evaluation of Clogging Recovery

Each of the prepared ink compositions was filled into the PX-A550 Inkjet Printer and after confirming that the ink compositions were discharged from all nozzles, the ink compositions were allowed to stand for 1 week in an environment at 40° C. without installing ink cartridges and with the printer head at a position other than the home position (state in which the printer head is shifted from the location of the cap equipped on the printer so that the printer head is not capped). Following completion of standing, the ink compositions were again discharged from the nozzles, the number of times cleaning was required until the printout was equivalent to the initial printout was measured, and those results were evaluated based on the following criteria.

A: Equivalent printout obtained with 3 rounds of cleaning or less

B: Equivalent printout obtained with 4 to 9 rounds of cleaning

C: Equivalent printout obtained with 10 or more rounds of cleaning

TABLE 12

| Evaluation | Examples | | | | | | | | | Comparative Examples | | | | |
|---|---|---|---|---|---|---|---|---|---|---|---|---|---|---|
| Parameters | 1 | 2 | 3 | 4 | 5 | 6 | 7 | 8 | 9 | 1 | 2 | 3 | 4 | 5 |
| Optical density (OD | A | A | A | B | A | B | A | A | A | A | B | A | B | B |
| value) | | | | | | | | | | | | | | |
| Printing quality | A | A | A | B | A | B | A | A | A | B | B | B | B | C |
| Cockling | A | A | B | A | AA | B | AA | AA | B | AA | C | C | C | A |
| Fixability | A | A | A | B | A | A | A | B | A | C | A | A | A | C |
| Discharge stability | A | A | A | A | B | A | B | B | A | C | A | A | A | C |
| Clogging recovery | A | A | A | B | A | B | B | B | B | C | A | A | A | C |

As previously explained, as a result of the ink composition of the present example which comprises at least a pigment, water-soluble inorganic solvent, surfactant and 60 to 10% by weight of water, wherein the water-soluble organic solvent at least contains 15% by weight or more of a polyvalent alcohol monoalkyl ether, having a water vapor pressure at 20° C. of 0.1 mmHg or less, and/or a nitrogen-containing cyclic compound, as well as a polyvalent alcohol, and the ratio of the contents of water (a), the polyvalent alcohol monoalkyl ether, having a water vapor pressure at 20° C. of 0.1 mmHg or less, and/or a nitrogen-containing cyclic compound (b), and the polyvalent alcohol (c) is (a):(b):(c)=1:0.25 to 8:0.1 to 7, it is able to improve printability on recording media having low ink absorbency. More specifically, these ink compositions have superior optical density, printing quality and fixability while ensuring reliability in terms of discharge stability, clogging recovery and the like, and are also able to suppress cockling and curling.

What is claimed is:

1. An ink composition at least comprising:
a pigment;
a water-soluble organic solvent;
a surfactant; and
60 to 10% by weight of water.

2. The ink composition according to claim 1, wherein the water-soluble organic solvent at least comprises 15% by weight or more of a polyvalent alcohol monoalkyl ether, having a water vapor pressure at 20° C. of 0.1 mmHg or less, and/or a nitrogen-containing cyclic compound, and a polyvalent alcohol.

3. The ink composition according to claim 2, wherein the weight ratio (a):(b):(c) of the contents of the water (a), the polyvalent alcohol monoalkyl ether, having a water vapor pressure at 20° C. of 0.1 mmHg or less, and/or nitrogen-containing cyclic compound (b), and the polyvalent alcohol (c) is 1:0.25 to 8:0.1 to 7.

4. The ink composition according to claim 2, wherein the polyvalent alcohol is a 1,2-alkanediol.

5. The ink composition according to claim 1, wherein the pigment is contained at 6% by weight or more.

6. The ink composition according to claim 1, wherein the pigment is a pigment coated with a water-insoluble polymer.

7. The ink composition according to claim 1, wherein the pigment is a self-dispersing pigment.

8. The ink composition according to claim 1, wherein the surfactant is an acetylene glycol-based surfactant and/or poly-modified siloxane-based surfactant.

9. The ink composition according to claim 1, further comprising a resin emulsion.

10. The ink composition according to claim 9, wherein the resin emulsion is a mixture of resin fine particles having a minimum film-forming temperature of 20° C. and above, and resin fine particles having a minimum film-forming temperature of below 20° C.

11. An inkjet recording method for carrying out printing by discharging liquid droplets of an ink composition and adhering the droplets to a recording medium,
wherein the ink composition according to claim 1 is used.

12. A recorded article, obtained by carrying out recording using the inkjet recording method according to claim 11.
